(19) United States
(12) Patent Application Publication
(10) Pub. No.: US 2026/0042939 A1
(43) Pub. Date: Feb. 12, 2026

(54) ELECTRICALLY CONDUCTIVE PRESSURE SENSITIVE ADHESIVES

(71) Applicant: 3M INNOVATIVE PROPERTIES COMPANY, St. Paul, MN (US)

(72) Inventors: Weigang Lin, Shanghai (CN); Vasav Sahni, St. Paul, MN (US); Jing Fang, Shanghai (CN); Claire Hartmann-Thompson, Lake Elmo, MN (US); Shane White, Stillwater, MN (US); Jie Huang, Shanghai (CN); Enzhong Zhang, Shanghai (CN); Lijing Zhang, Shanghai (CN)

(21) Appl. No.: 19/099,679

(22) PCT Filed: Aug. 26, 2022
(86) PCT No.: PCT/CN2022/115183

§ 371 Date: Jan. 29, 2025

(51) Int. Cl. C09J 9/02; C09J 7/38; C09J 153/02

(52) U.S. Cl. CPC C09J 9/02; C09J 7/387; C09J 153/02; C09J 2203/326; C09J 2301/312; C09J 2301/314; C09J 2301/408; C09J 2453/00

(57) ABSTRACT

Conductive adhesives include a pressure sensitive adhesive matrix and electrically conductive particles. The matrix includes at least one non-linear block copolymer with aromatic end blocks and aliphatic elastomeric blocks, at least one hydrocarbon-based tackifying resin, and at least one aromatic reinforcing resin. The conductive adhesive is a pressure sensitive adhesive and has a 180° peel adhesion of at least 15.0 newtons/decimeter at room temperature, and when disposed on a copper foil substrate has a DC resistance of less than 0.4 ohms as measured by ETM-7. Upon aging on a conductive fabric substrate for at least 1 week at 85° C. and 85% relative humidity, the 180° peel adhesion changes by 25% or less.

### FIELD OF THE DISCLOSURE

The current disclosure relates to electrically conductive pressure sensitive adhesives and articles prepared with these pressure sensitive adhesives.

### BACKGROUND

A wide range of adhesives and adhesive articles are used in optical and electronic applications. These adhesive articles include pressure sensitive adhesives as well as structural and semi-structural adhesives.

In electronic assembly devices such as smart phones and tablets, there are many applications that need conductive tapes and conductive gaskets to work as grounding and/or shielding materials. Conductive pressure sensitive adhesives (CPSAs) and articles that contain CPSAs are among the components used in the electronic devices. These CPSAs are used not only to adhere elements of the devices together (the typical role of PSAs), but also are called upon to provide additional roles within the device. Conductive PSAs have contradictory requirements, typically they need to have high electrical conductivity for grounding performance and adhere strongly to electrical components without adversely affecting the electrical components.

### SUMMARY

Disclosed herein are conductive adhesives and articles prepared with the conductive adhesives. The conductive adhesive comprises a pressure sensitive adhesive matrix and electrically conductive particles. In some embodiments, the pressure sensitive adhesive matrix comprises at least one non-linear block copolymer comprising aromatic end blocks and aliphatic elastomeric blocks, at least one hydrocarbon-based tackifying resin, and at least one aromatic reinforcing resin. The conductive adhesive is a pressure sensitive adhesive and has a variety of desirable properties including high Peel Adhesion, low DC Resistance, and resistance to high temperature and humidity aging. When disposed on a 50-micrometer thick PET (polyethylene terephthalate) backing the conductive adhesive has a 180° Peel Adhesion of at least 15.0 Newtons/decimeter at Room Temperature. The conductive adhesive when disposed on a copper foil backing has a DC Resistance of less than 0.4 ohms as measured by ETM-7. Upon aging on a conductive fabric substrate for at least 1 week at 85° C. and 85% Relative Humidity, the 180° Peel Adhesion changes by 25% or less.

Also disclosed herein are electrically conductive articles. The electrically conductive article comprises a substrate with a first major surface and a second major surface, and an electrically conductive adhesive layer disposed on at least a portion of the second major surface of the substrate. The conductive adhesive is described above and comprises a pressure sensitive adhesive matrix and electrically conductive particles. In some embodiments, the pressure sensitive adhesive matrix comprises at least one non-linear block copolymer comprising aromatic end blocks and aliphatic elastomeric blocks, at least one hydrocarbon-based tackifying resin, and at least one aromatic reinforcing resin. The conductive adhesive is a pressure sensitive adhesive and has a variety of desirable properties including high Peel Adhesion, low DC Resistance, and resistance to high temperature and humidity aging. When disposed on a 50-micrometer thick PET (polyethylene terephthalate) backing the conductive adhesive has a 180° Peel Adhesion of at least 15.0 Newtons/decimeter at Room Temperature. The conductive adhesive when disposed on a copper foil backing has a DC Resistance of less than 0.4 ohms as measured by ETM-7. Upon aging on a conductive fabric substrate for at least 1 week at 85° C. and 85% Relative Humidity, the 180° Peel Adhesion changes by 25% or less.

### BRIEF DESCRIPTION OF THE DRAWINGS

The present application may be more completely understood in consideration of the following detailed description of various embodiments of the disclosure in connection with the accompanying drawings.

FIG. 1 is a cross sectional view of a device for testing PIM (passive intermodulation) of adhesives.

FIG. 2 is a cross sectional view of another device for testing PIM (passive intermodulation) of adhesives.

FIG. 3 is a cross sectional view of another device for testing PIM (passive intermodulation) of adhesives.

### DETAILED DESCRIPTION

In electronic assembly devices such as smart phones and tablets, there are many applications that need conductive tapes and conductive gaskets to work as grounding and/or shielding materials. Conductive pressure sensitive adhesives (CPSAs) and articles that contain CPSAs are among the components used in the electronic devices. These CPSAs are used not only to adhere elements of the devices together (the typical role of PSAs), but also are called upon to provide additional roles within the device. Conductive PSAs have contradictory requirements, typically they need to have high electrical conductivity for grounding performance and adhere strongly to electrical components without adversely affecting the electrical components. Since the electrical components are often subject to corrosion and degradation (such as layers of copper and conductive fabrics for example), many typical materials used in pressure sensitive adhesives are not optimal (such as acid- or base-functional materials) for use in CPSAs.

One desire in electronic devices is for a reduction in passive intermodulation (PIM). PIM is generated when two or more signals at different frequencies mix with each other due to electrical nonlinearities. In some cases, the PIM signal resulting from wireless transmission of a signal can occur at a frequency inside a receiving band of the wireless communication or data device, thereby causing undesired signal interference. Methods for measuring PIM are described below and are shown in the Figures. Therefore, the need remains for conductive PSAs that have and maintain good PSA properties (such as peel and shear properties) even when aged at elevated temperatures and humidity levels, good conductive properties, and provide a low level of PIM.

In this disclosure, conductive PSAs are described that have and maintain good PSA properties (such as peel and shear properties), good conductive properties, and provide a low level of PIM. The conductive PSAs comprise a pressure sensitive adhesive matrix comprising at least one non-linear block copolymer comprising aromatic end blocks and aliphatic elastomeric blocks, at least one hydrocarbon-based tackifying resin, at least one aromatic reinforcing resin, and electrically conductive particles dispersed within the matrix. Also disclosed are articles prepared using this conductive pressure sensitive adhesive.

The term “adhesive” as used herein refers to polymeric compositions useful to adhere together two adherends. Examples of adhesives are pressure sensitive adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The terms “room temperature” and “ambient temperature” are used interchangeably to mean temperatures in the range of 20° C. to 25° C.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. The term “polymer” is used to describe the resultant material formed from a polymerization reaction.

Disclosed herein are conductive adhesives. The conductive adhesives comprise a pressure sensitive adhesive matrix and electrically conductive particles. The pressure sensitive adhesive matrix comprises at least one non-linear block copolymer comprising aromatic end blocks and aliphatic elastomeric blocks, at least one hydrocarbon-based tackifying resin, and at least one aromatic reinforcing resin. The conductive adhesive is a pressure sensitive adhesive and when disposed on a 50-micrometer thick PET (polyethylene terephthalate) backing has a 180° Peel Adhesion of at least 15.0 Newtons/decimeter at Room Temperature (0.15 N/mm), and when disposed on a copper foil backing has a DC Resistance of less than 0.4 ohms as measured by ETM-7. The conductive adhesive has temperature and moisture stability such that the 180° Peel Adhesion changes by 25% or less after aging on a conductive fabric substrate for at least 1 week at 85° C. and 85% Relative Humidity.

The conductive adhesive can be tested for PIM (passive intermodulation) in a variety of ways as is described in greater detail below, in the Examples section and in the Figures. One method involves forming a tape, the tape comprising a layer of the conductive adhesive and an electrically conductive layer such as a conductive woven or non-woven layer. The tape is placed in a test fixture comprising gold conductive surfaces. When first and second electrical signals propagate in the thickness direction of the conductive adhesive layer between the gold surfaces at respective frequencies F1 and F2, any intermodulation signal generated from the first and second electrical signals has a frequency F3 equal to nF1+mF2, where m and n positive or negative integers. The PIM at any given values of m and n, resulting from two such signals at F1 and F2 each at 43 dBm of power, through the conductive adhesives of this disclosure, have a power of less than about −95 dBm relative to a total power of the first and second signals.

It should be noted that properties of the adhesive such as 180° Peel Adhesion, DC resistance, and PIM are properties of the conductive adhesive. While the conductive adhesive is, for example formed into a tape by disposing the adhesive onto a 50-micrometer PET backing for 180° Peel Adhesion testing, the property is a property of the adhesive itself and does not mean that the adhesive can only be used in the form of a tape. The method of testing involves the formation of a tape to carry out the testing, but the properties listed are of the adhesive itself.

The conductive adhesive comprises a pressure sensitive adhesive matrix. The pressure sensitive adhesive matrix comprises at least one non-linear block copolymer comprising aromatic end blocks and aliphatic elastomeric blocks, at least one hydrocarbon-based tackifying resin, and at least one aromatic reinforcing resin.

A wide range of non-linear block copolymers comprising aromatic end blocks and aliphatic elastomeric blocks are suitable. The non-linear block copolymers are not simple A-B-A block copolymers. In some embodiments, the at least one non-linear block copolymer comprises a star or comb copolymer. Star block copolymers are also sometimes referred to as radial block copolymers.

In some embodiments of the block copolymer, the aromatic end blocks comprise styrene blocks, and the aliphatic elastomeric blocks comprise isoprene, farnesene, or a combination thereof. Particularly suitable polymers include radial styrene-isoprene-styrene block copolymers and styrene-farnesene-styrene block copolymers. Examples of commercially available radial styrene-isoprene-styrene block copolymers include those available from Kraton Polymers, Houston, TX under the trade names, D1340KT, and DL1124KT. Examples of commercially available radial styrene-farnesene-styrene block copolymers include SF902 from Kuraray, Tokyo, Japan. A particularly suitable radial block copolymer comprises a star copolymer with styrene end blocks and isoprene elastomeric blocks wherein the end blocks comprise styrene that is 9-10% by weight of the total polymer.

The pressure sensitive adhesive matrix further comprises at least one hydrocarbon tackifying resin. The hydrocarbon tackifying resin comprises a hydrogenated or partially hydrogenated hydrocarbon resin. A wide range of hydrogenated or partially hydrogenated hydrocarbon resins are suitable. Examples of commercially available hydrogenated or partially hydrogenated hydrocarbon resin include the resins ARKON P100, ARKON P125, and ARKON P140 from Arakawa Chemical, Inc. Chicago, IL.

The pressure sensitive adhesive matrix further comprises at least one aromatic reinforcing resin. In some embodiments, the aromatic reinforcing resin comprises a thermoplastic aromatic co-polymer with a Tg (glass transition temperature) of greater than 100° C. A wide range of aromatic resins are suitable. An example of a commercially available aromatic reinforcing resin is ENDEX 160 from Eastman Chemical Company, Kingsport, TN.

The conductive adhesive further comprises electrically conductive particles dispersed within the pressure sensitive adhesive matrix. A wide range of electrically conductive particles are suitable. The electrically conductive filler particles can be in the form of metallic particles or metal coated insulative (e.g., polymeric) particles or combinations thereof. In some embodiments, the electrically conductive particles comprise particles of nickel-coated graphite. The amount of electrically conductive particles present in the conductive adhesive can vary as will be described below. One particularly suitable conductive particle is the nickel-coated graphite particle “E-Fill #2806 Ni” commercially available from Oerlikon Metco, Westbury, NY.

The conductive adhesive may optionally include at least one additive. Particularly suitable additives include conductive nanoparticles. It was surprising found that the addition of a very small amount of such conductive nanoparticles can provide desirable improvements in the conductive adhesive. Among the improvements discovered by the addition of small amounts of conductive nanoparticles are improvements in conductivity and reduction in PIM.

Examples of suitable conductive nanoparticles include carbon nanotubes, metallic nanoparticles including nanowires, nanoflakes, nanograins, and nanospheres.

A carbon nanotube (CNT) is a tube made of carbon with diameters typically measured in nanometers. They are a relatively new class of materials and are becoming commercially available.

Single-wall carbon nanotubes (SWCNTs) are one of the allotropes of carbon, intermediate between fullerene cages and flat graphene, with diameters in the range of a nanometer to several nanometers. Although not made this way, single-wall carbon nanotubes can be idealized as cutouts from a two-dimensional hexagonal lattice of carbon atoms rolled up along one of the Bravais lattice vectors of the hexagonal lattice to form a hollow cylinder. In this construction, periodic boundary conditions are imposed over the length of this roll-up vector to yield a helical lattice of seamlessly bonded carbon atoms on the cylinder surface.

Multi-wall carbon nanotubes (MWCNTs) consist of nested single-wall carbon nanotubes weakly bound together by van der Waals interactions in a tree ring-like structure. Multi-wall carbon nanotubes are also sometimes used to refer to double- and triple-wall carbon nanotubes.

In some embodiments, the conductive nanoparticles comprise carbon nanotubes selected from: SWNT (single-walled nanotubes) or MWNT (multi-walled nanotubes); nickel nanowires; or a combination thereof. Typically, the carbon nanotubes or nickel nanowires are supplied in a solvent. A suitable commercial example of CNTs is “DM-NMP-0.4” (0.4% CNT dispersed in NMP) from Shanghai DM-Star Ltd. A suitable commercial example of nickel nanowires includes “NovaWire-Ni-200-Alcohol” (0.5% nickel nanowires dispersed in alcohol) from Shanghai Jiaxin Ltd.

The conductive adhesive matrix formulations can have a wide range of component compositions. In some embodiments, the conductive adhesive comprises: a pressure sensitive adhesive matrix, where the pressure sensitive adhesive matrix comprises: 40-70 parts by weight of at least one non-linear block copolymer; 30-60 parts by weight of hydrocarbon-based tackifying resin; and 2-8 parts by weight aromatic reinforcing resin; and 15-30 parts by weight electrically conductive particles. Parts by weight are used to describe these formulations instead of weight % as the weight components do not necessarily add up to 100.

As was mentioned above, the conductive adhesives have a wide range of desirable properties. Among these properties are adhesive properties (180° Peel Adhesion) and electrical properties (DC resistance and PIM). Each of these properties is described below. The conductive adhesive is a pressure sensitive adhesive, meaning that has the features characteristic of a pressure sensitive adhesive: (1) aggressive and permanent tack, (2) adherence with no more than finger pressure, (3) sufficient ability to hold onto an adherend, and (4) sufficient cohesive strength to be cleanly removable from the adherend. One test commonly used to measure the adhesive properties of a pressure sensitive adhesives is 180° Peel Adhesion. In this test the adhesive is disposed on a backing and peeled from a test surface as described in the test method in the Examples section. In some embodiments, the conductive adhesive has a 180° Peel Adhesion of at least 15.0 Newtons/decimeter (0.15 N/mm) at Room Temperature. In other embodiments, the conductive adhesive has a 180° Peel Adhesion of at least 20.0 Newtons/decimeter at Room Temperature (0.20 N/mm) or even 30 N/dm (0.3 N/mm).

The conductive adhesive also has desirable electrical properties. Among these properties are DC resistance and PIM. The conductive adhesive has a DC Resistance of less than 0.4 ohms as measured by ETM-7. The test method ETM-7 is described in the Examples section below. In some embodiments, the conductive adhesive has a DC Resistance of less than 0.35 ohms, or even less than 0.3 ohms.

As mentioned above, an important feature of the current conductive adhesives is their stability when exposed to heat and humidity, especially when the adhesive is in contact with a conductive substrate such as a conductive fabric. In some embodiments, the conductive adhesive 180° Peel Adhesion changes by 25% or less after aging on a conductive fabric substrate for at least 1 week at 85° C. and 85% Relative Humidity.

Layers of adhesive are generally described as having length and width in the x-y plane and have a thickness along the z-axis. The conductive adhesives of this disclosure are generally “z-axis conductive adhesives”. By this it is meant that a layer of the adhesive conducts in the z-axis, which is the thickness of the layer of adhesive, and does not necessarily conduct in the x-y plane of the layer of adhesive.

The adhesive layers of this disclosure can be prepared from the conductive adhesive compositions. The layers can be prepared by disposing the adhesive composition on the surface of a substrate such as a release liner. The adhesive layers can be provided in a variety of ways such as a sheet or as a roll, where the roll can be rolled upon itself for shipment or storage and unrolled when used.

Another important feature of the conductive adhesives of this disclosure is the relatively low PIM (passive intermodulation). PIM can be tested in a variety of ways as shown in the Figures.

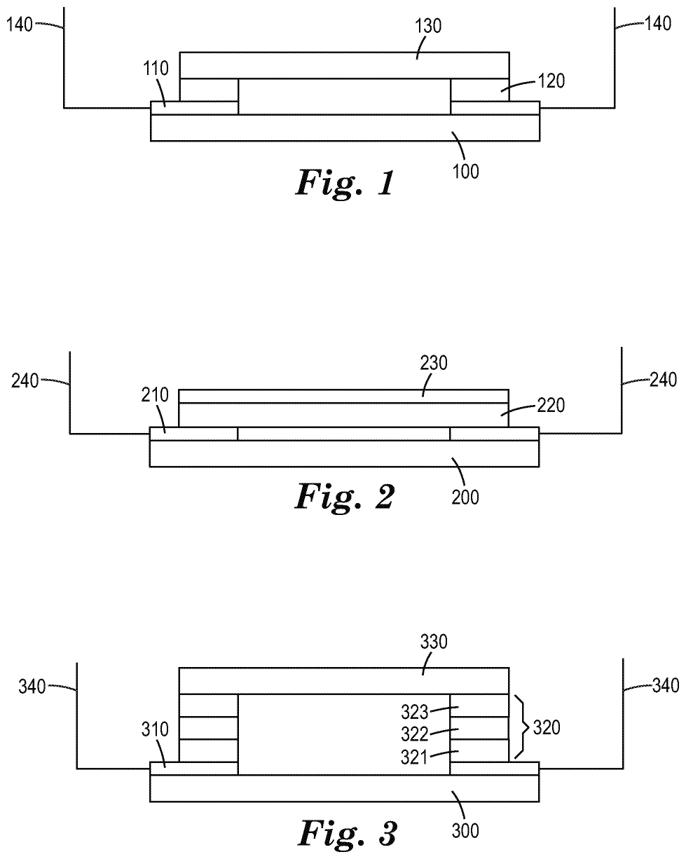

The Figures shows three methods for testing PIM. In the first method (FIG. 1), the adhesive itself is used. Samples of the adhesive are disposed on the gold portions of the PIM test board. The samples are connected by a conductive bridge, typically metal. Because the adhesive is a z-axis conductive adhesive, the adhesive samples form a conductive link between the gold portions and the conductive bridge. In FIG. 1, PIM test board 100 has gold portions 110 and wires 140. The test sample includes adhesive 120 with conductive bridge 130. In the second method (FIG. 2), the adhesive is formed into a single-sided tape with a conductive tape backing. This tape backing may be metallic or it may be a conductive woven or non-woven. The single-sided tape is disposed on and between the gold portions of the PIM test board such that the conductive adhesive is in contact with the gold portions. In this way, the conductive tape backing is serving as the conductive bridge. In FIG. 2, PIM test board 200 has gold portions 210 and wires 240. The test sample includes adhesive layer 220 with conductive tape backing 230. In the third method (FIG. 3), a double-side tape is used that comprises two layers of conductive adhesive with a conductive interlayer disposed between. The conductive interlayer may be a variety of conductive layers such as a metallic layer or a layer of conductive woven or non-woven. Samples of the double-sided tape are disposed on the gold portions of the PIM board, and a conductive bridge connects the samples. This configuration is very similar to that for the first method, except that the sample is a multi-layer sample of conductive adhesive/conductive interlayer/conductive adhesive instead of simply being the conductive adhesive. In FIG. 3, PIM test board 300 has gold portions 310 and wires 340. The test sample includes adhesive layer 320 with conductive bridge 330. Adhesive layer 320 has sublayers, these sublayers are sublayer 321 that is the adhesive sample, sublayer 322 is a conductive interlayer, and sublayer 323 is the adhesive sample.

It should be understood that the method of testing of the adhesive for PIM is not limiting on articles that can be made from the conductive adhesive but that regardless of how the PIM is measured, the property is that of the conductive adhesive and not of articles of the adhesive (such a single-sided tapes, double-sided tapes and the like). One suitable method for measuring the PIM of the conductive adhesive is that of the second method, where a single-sided tape with an electrically conductive non-woven tape backing comprising metal coated polymer fibers is used, and the tape is placed in the test fixture. When first and second electrical signals propagate in the thickness direction (z-axis) of the conductive adhesive layer at respective frequencies F1 and F2 each at 43 dBm of power, any intermodulation signal generated has a frequency F3 equal to nF1+mF2, m and n positive or negative integers. When measured in this way, the PIM has a power of less than about −95 dBm relative to a total power of the first and second signals.

Also disclosed herein are electrically conductive articles. In some embodiments, the electrically conductive article comprises a substrate with a first major surface and a second major surface, and an electrically conductive adhesive layer disposed on at least a portion of the second major surface of the substrate. The electrically conductive adhesive has been described in detail above. In some embodiments, the conductive adhesive comprises a pressure sensitive adhesive matrix and electrically conductive particles dispersed within the matrix. The pressure sensitive adhesive matrix comprises at least one non-linear block copolymer comprising aromatic end blocks and aliphatic elastomeric blocks, at least one hydrocarbon-based tackifying resin, and at least one aromatic reinforcing resin. The conductive adhesive is a pressure sensitive adhesive and when disposed on a 50-micrometer thick PET (polyethylene terephthalate) backing has a 1800 Peel Adhesion of at least 15.0 Newtons/decimeter at Room Temperature (0.15 N/mm), and when disposed on a copper foil backing has a DC Resistance of less than 0.4 ohms as measured by ETM-7. The 180° Peel Adhesion changes by 25% or less after aging on a conductive fabric substrate for at least 1 week at 85° C. and 85% Relative Humidity.

A wide variety of substrates are suitable. In some embodiments, the substrate comprises an electrically conductive substrate. These embodiments can be described as “single-sided tapes” as they have a single side of exposed adhesive. A wide range of electrically conductive substrates are suitable. Examples of suitable conductive substrates include a non-woven layer comprising metal coated polymer fibers, a woven fabric layer comprising metal coated polymer fibers, a film layer with metal coated surface(s), or a metal foil. Metal can be deposited on fibers or films in a wide variety of ways such as by coating, sputtering, electroplating, or chemical vapor deposition.

In other embodiments, the substrate comprises a release liner. In these embodiments, the conductive adhesive layer is a free-standing adhesive layer where both surfaces of the adhesive layer are exposed. These free-standing adhesive layers can be used in a wide variety of ways. The exposed adhesive surface can be laminated to a conductive substrate to form a single-sided tape as described above. The free-standing adhesive layer can be used as it is and laminated to a surface, the release liner can be removed to expose the second surface of the adhesive and a substrate or surface can be adhered to the newly exposed surface. The free-standing adhesive layer can also be laminated to the opposite surface of a single-sided adhesive tape as described above to form a double-sided adhesive tape.

Release liners are well understood in the adhesive arts as being a film from which adhesive compositions or coatings can be readily removed. Exemplary release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like, and combinations thereof). At least some release liners are coated with a layer of a release agent such as a silicone, a fluorosilicone-containing material or a fluorocarbon-containing material.

### Examples

These examples are merely for illustrative purposes only and are not meant to be limiting on the scope of the appended claims.

TABLE 1
Materials List

| Material | Description | Source |
|---|---|---|
| SIS-1 | Styrene-Isoprene-Styrene-1, a dissimilar | Kraton Polymers US |
| | arm, styrene-isoprene, star polymer with | LLC, Houston, TX |
| | 9.2% styrene content and made | |
| | according to U.S. Pat. No. 5,393,787 | |
| S1S-2 | Styrene-Isoprene-Styrene-2, | Kraton Polymers US |
| | commercially available under the trade | LLC |
| | designation KRATON D1124K | |
| SIS-3 | Styrene-Isoprene-Styrene-3, SL177 | Zeon Corporation, |
| | | Tokyo, Japan |
| SIS-4 | Styrene-Isoprene-Styrene-4, available | Kraton Polymers US |
| | under the trade designation KRATON | LLC |
| | G1657 | |
| SIS-5 | Styrene-Isoprene-Styrene-5, available | Kraton Polymers US |
| | under the trade designation KRATON | LLC |
| | G1726 | |
| SFS | Styrene-Farnesene-Styrene, available | Kuraray, Tokyo, |
| | under the trade designation SEPTON | Japan |
| | BIO-Series SF902 | |
| HHR-1 | Hydrogenated Hydrocarbon Resin-1, | Arakawa Chemical |
| | available under the trade designation | Inc., Chicago, IL |
| | ARKON P100 | |
| HHR-2 | Hydrogenated Hydrocarbon Resin-2, | Arakawa Chemical |
| | available under the trade designation | Inc. |
| | ARKON P125 | |
| HHR-3 | Hydrogenated Hydrocarbon Resin-3, | Arakawa Chemical |
| | available under the trade designation | Inc. |
| | ARKON P140 | |
| HHR-4 | Hydrogenated Hydrocarbon Resin-4, | Eastman Chemical |
| | available under the trade designation | Company, |
| | REGALREZ 1126 | Kingsport, TN |
| HHR-5 | Hydrogenated Hydrocarbon Resin-5, | ExxonMobil, Irving, |
| | available under the trade designation | TX, United States |
| | ESCOREZ 5673 | |
| RESIN-1 | Resin-1, thermoplastic resin end block | Eastman Chemical |
| | reinforcer, available under the trade | Company |
| | designation ENDEX 160 | |
| TACK-1 | Tackifier-1, rosin resin tackifier | Eastman Chemical |
| | available under the designation Foral | Company |
| | 85 ® | |
| AO-1 | Anti-oxidation Agent-1, available under | BASF Corporation, |
| | the designation Inrganox ® 1010 | Ludwigshafen, |
| | | Germany |
| PIB | Polyisobutylene, available under the | BASF Corporation |
| | designation X16 | |
| RL-1 | Release Liner-1, available as RF 22N | SKC Haas, Korea |
| RL-2 | Release Liner-2, available as RF 02N | SKC Haas, Korea |
| PET Film | Polyethylene terephthalate film, | SKC Inc, Eighty |
| | available under the designation | Four, PA, United |
| | Skyrol ® SH81 | States |
| WF-1 | Woven Fabric-1, conductive woven | Shanghai Jiaxin Ltd, |
| | fabric available under the designation | Shanghai, China |
| | JX B1925 | |
| Graphite | Ni-coated graphite, available as EFILL | Oerlikon Metco, |
| | 2806 | Canada |
| TOL | Toluene | EMD Millipore, |
| | | Burlington, MA |
| HEP | Heptane | EMD Millipore |
| XYL | Xylene | EMD Millipore |
| MEK | Methyl Ethyl Ketone | EMD Millipore |
| EA | Ethyl Acetate | EMD Millipore |
| CNT | Carbon Nanotube, available as | Shanghai XingTi |
| | DM-NMP- | New Material Co., |
| | 0.4% | Ltd |
| CU-1 | 30 micrometer thick ED copper foil | Maitong, Ltd, China |
| CU-2 | 12 micrometer thick ED copper foil | Maitong, Ltd, China |

### Mechanical Tests

### Static Shear

The test was conducted at 70° C. An adhesive sample was laminated on a 50 μm thick PET film. Test specimen were cut out of the sample material having a dimension of 12.7 mm by 175 mm. The liner was then removed, and the adhesive was adhered onto to stainless steel plate with an overlap of 12.7 mm×25.4 mm. A loop was prepared at the end of the test strip to hold a specified weight. Next, the test samples were rolled four times with a standard FINAT test roller (weight 2 kg) at a speed of approximately 10 mm per second to obtain intimate contact between the adhesive and the surface. The test samples are allowed to dwell for 24 hours at ambient room temperature (23° C.+/−2° C., 50% relative humidity+1-5%) prior to testing.

Each sample was then placed into a vertical shear-stand (+2° disposition) at 70° C. with automatic time logging. After ten minutes dwell time in the oven, a 500 g weight was hung into the loop. The time until failure was measured and recorded in minutes. Target value was 10.000 minutes. Two samples were measured for each construction. A recorded time of “>10,000” indicates that the adhesive did not fail after 10,000 minutes. Failure modes were given as followed: PO for pop-off, AT for adhesive transfer and CF for cohesive failure.

### Peel Adhesion

ASTM D3330/D3330M was followed. For adhesive transfer tapes or double-sided tapes, the release liner on one side was removed, and the adhesive transfer tape samples or double side tape samples were laminated onto a 50 micrometer thick PET film, to prepare a single-sided tape sample. The second release liner was removed, the exposed adhesive surface was applied to a Stainless-Steel substrate and allowed to dwell at room temperature for 20 minutes (RT 20 min) or 72 hours (RT 72 hrs), after which they were peeled at 30.5 cm per minute at 180°. Three measurements were taken, and average peel values were noted.

Rheological Performance (Tg, G′, and tan delta)

Samples were evaluated using a rheological dynamic analyzer (Model DHR-3 Rheometer, obtained from TA Instruments, New Castle, DE, USA). One millimeter (0.039 inch) thick samples were punched out using an 8-millimeter (0.315 inches) diameter circular die. The punched-out samples were then adhered onto an 8-millimeter diameter upper parallel plate after removal of the release liner. The plate with polymeric film was positioned between the clamps, and the polymeric film was compressed until the edges of the sample were uniform with the edges of the top plate. The temperature was then equilibrated at the test temperatures for two minutes at a nominal axial force of 0 grams+/−15 grams. After two minutes, the axial force controller was disabled to maintain a fixed gap for the remainder of the test. The sample was oscillated at 1 Hz and was taken from −50° C. to 150° C. at 3° C./min.

### Electrical Tests

### Single-Sided Tape Sample Preparation

One sheet of 20 μm thick 17.8 cm×17.8 cm sample was laminated onto matte side of a specific copper foil using a seam roller. Each of the foil samples was passed through a laminator with a rubber roller at the bottom and a steel roller at the top (ChemInstruments Hot Roll Laminator, HL-200) at room temperature and a pressure of 0.34 MPa (50 psi, controlled by an air regulator). After lamination, the samples were annealed in an oven at 40° C. for four days before measurement.

### Double-Sided Tape Sample Preparation

Two sheets of 20 μm thick 17.8 cm×17.8 cm samples were laminated onto a 22 μm thick nickel/copper coated fabric using a seam roller. Each of the fabric samples was passed through a laminator with a rubber roller at the bottom and a steel roller at the top (ChemInstruments Hot Roll Laminator, HL-200) at room temperature and a pressure of 0.34 MPa (50 psi, controlled by an air regulator). After lamination, the samples were annealed in an oven at 40° C. for four days before measurement.

### Passive Intermodulation (PIM)

A test fixture, comprised of a 50 Ohm microstrip test board and mechanically connected coaxial cables, was used to measure PIM of the samples. The test board was 50 mm×80 mm×60 mil FR-4 dielectric with 1 oz copper having an ENIG (electroless nickel, immersion gold) finish. The microstrip line was 3 mm wide with a 10 mm gap centered along the board length to break the circuit. Two 3 mm×15 mm adhesive samples were adhered manually (by finger pressure) on either side of the 10 mm gap in the microstrip line. A 40 mm×3 mm×1 mm stainless steel 316L bridge was aligned to the samples and gap and connected using 0.103 MPa (15 psi) pressure, completing the electrical circuit. The samples were left to dwell for at least twenty minutes before measurement. A Rosenberger desktop PIM analyzer (Tittmoning, Germany) was connected to the test fixture to perform the measurement. Two frequency signals between 729-758 MHz of 30 dBm (1 W) were swept over the LTE700L cellular band and the maximum reflected third-order (IM3) value was recorded.

### ETM-7, Resistance Through the PSA, XY-Axis

A strip of the single side conductive tape with adhesive side down was placed between the electrodes on 3M ETM-7 (St. Paul, MN, United States) boards. After initial hand lamination to provide for a 10 mm×10 mm contact area between the tape and the electrodes, a 2 kg rubber roller was applied across the tape. After 20 minutes of dwell time, the DC resistance between the electrodes was measured with a micro-ohm meter.

### ETM-12, Resistance Through the PSA, Z-Axis

An adhesive transfer tape or a double side tape sample was cut into 10 mm×10 mm pieces and two pieces were placed with one adhesive side down on the center of each of the electrodes on 3M ETM-7 (St. Paul, MN, United States) boards. After initial hand lamination and removal of the liners place 3M ETM-12 board with the metal side down on the tapes, a 2 kg rubber roller was applied across the ETM-12 board. After 20 minutes of dwell time, the DC resistance between the electrodes was measured with a micro-ohm meter.

$$( EX 1 - EX 10 ) \qquad Examples 1 - 10$$

Quantities of materials (in grams) listed in Table 2 were added to a glass jar after which a mixture of HEP with MEK or EA was added to make a 30% solids solutions. The jars were rolled for 12 hours under heat lamps to form homogenous solutions. The solutions were then coated on a RL-1 (50 μm thick) using a knife coater with a gap of 63.5 μm (2.5 mil). The coated samples were placed in an oven at 70° C. for 15 minutes. RL-2 (50 μm thick) was then laminated onto each of the dried samples.

TABLE 2
Compositions (in grams)

| | SIS-3 | SIS-2 | SIS-1 | SFS | HHR-1 | HHR-2 | HHR-3 | RESIN-1 | Graphite | CNT | Solvent |
|---|---|---|---|---|---|---|---|---|---|---|---|
| EX1 | 0 | 0 | 60 | 0 | 0 | 40 | 0 | 5 | 20 | 0 | 3:1 HEP:EA |
| EX2 | 0 | 0 | 60 | 0 | 0 | 40 | 0 | 5 | 20 | 0 | 1:1 HEP:MEK |
| EX3 | 0 | 0 | 60 | 0 | 0 | 40 | 0 | 5 | 21.6 | 8.5 | 1:1 HEP:MEK |
| EX4 | 0 | 0 | 60 | 0 | 0 | 40 | 0 | 5 | 25 | 0 | 3:1 HEP:EA |
| EX5 | 0 | 0 | 50 | 0 | 50 | 0 | 0 | 5 | 20 | 0 | 3:1 HEP:EA |
| EX6 | 50 | 0 | 0 | 0 | 50 | 0 | 0 | 5 | 20 | 0 | 3:1 HEP:EA |
| EX7 | 0 | 50 | 0 | 0 | 50 | 0 | 0 | 5 | 20 | 0 | 3:1 HEP:EA |
| EX8 | 0 | 0 | 0 | 60 | 0 | 40 | 0 | 5 | 15 | 0 | 3:1 HEP:EA |
| EX9 | 0 | 0 | 0 | 60 | 0 | 0 | 40 | 5 | 15 | 0 | 3:1 HEP:EA |
| EX10 | 0 | 0 | 0 | 60 | 0 | 40 | 0 | 5 | 25 | 0 | 3:1 HEP:EA |

Peel Adhesion testing was performed, and the results are represented in Table 3. Static Shear testing was performed, and all examples recorded a time of greater than 10,000 minutes.

TABLE 3
Peel Adhesion (N/dm) Test Results

| | RT 20 min | RT 72 hrs |
|---|---|---|
| EX1 | 34.6 | 38.1 |
| EX2 | 37.1 | 39.4 |
| EX3 | 16.3 | 21.5 |
| EX4 | 35.2 | 38.3 |
| EX5 | 44.7 | 43.5 |
| EX6 | 38.9 | 40.3 |
| EX7 | 70.7 | 69.6 |
| EX8 | 80.0 | NT |
| EX9 | 91.0 | NT |
| EX10 | 70.0 | NT |

NT indicates not tested

Electrical testing was carried out as described above and the data are presented in Table 4. Samples of Examples EX1-EX10 were laminated to copper foil CU-2 and became single side tapes for ETM-7 test. Samples of Examples EX1-EX10 were laminated to conductive fabric WF-1 and became double side tapes for ETM-12 test.

TABLE 4
Electrical Testing Results

| | ETM-7 (Ω) | ETM-12 (Ω) | PIM (dBm) |
|---|---|---|---|
| EX1 | 0.09-0.12 | 0.02 | −75.0 |
| EX2 | 0.06-0.07 | 0.02 | −91.1 |
| EX3 | 0.04-0.05 | 0.02 | −97.4 |
| EX4 | 0.06-0.08 | 0.05 | −81.9 |
| EX5 | 0.11-0.12 | 0.03 | −67.6 |
| EX6 | 0.14-0.18 | 0.02 | −95.1 |
| EX7 | 0.22-0.28 | 0.04 | −94.1 |
| EX8 | 0.04-0.10 | 0.04 | −83.6 |
| EX9 | 0.10-0.25 | 0.06 | −77.1 |
| EX10 | 0.06-0.12 | 0.03 | −96.3 |

NT indicates not tested

Samples of Examples EX1-EX7 were laminated onto both sides of conductive fabric WF-1 and aged for 1 week at 85° C. and 85% Relative Humidity, and then tested for Peel Adhesion. These data are presented in Table 5.

TABLE 5
Post Aging Peel Adhesion Testing Results

| | Peel Adhesion without aging | Peel Adhesion with aging |
|---|---|---|
| | (N/dm) | (N/dm) |
| EX1 | 54.0 | 40.9 |
| EX2 | 60.7 | 51.3 |
| EX3 | 45.9 | 39.2 |
| EX4 | 48.8 | 42.7 |
| EX5 | 79.2 | 66.7 |
| EX6 | 58.4 | 47.3 |
| EX7 | 51.8 | 46.2 |
| EX8 | 44.5 | 43.3 |
| EX9 | 8.0 | 23.7 |
| EX10 | 20.6 | 16.6 |

$$( EX 11 - EX 18 ) \qquad Examples 11 - 18$$

Quantities identified in Table 6 were mechanically mixed until all components were well dissolved or dispersed. The mixtures were spread onto a coater comma bar on 50-micrometer PET liners (Hongqing Ltd., Guangdong, China) and put into oven at 90° C. for five minutes. The samples were then laminated to another PET liner. Mechanical testing was conducted, and the results are represented in Table 7

TABLE 6
Compositions (in grams)

| | SIS- | SIS- | | TACK- | HHR- | Graph- | |
|---|---|---|---|---|---|---|---|
| | 4 | 3 | PIB | 1 | 5 | ite | Solvent |
| EX11 | 20 | 0 | 10 | 0 | 30 | 20 | 1:1 HEP:XYL |
| EX12 | 30 | 0 | 15 | 0 | 30 | 25 | 1:1 HEP:XYL |
| EX13 | 22.5 | 0 | 22.5 | 0 | 30 | 25 | 1:1 HEP:XYL |
| EX14 | 0 | 48 | 0 | 0 | 36 | 28 | 1:1 HEP:MEK |
| EX15 | 0 | 48 | 0 | 0 | 36 | 21 | 1:1 HEP:MEK |
| EX16 | 0 | 40 | 0 | 0 | 40 | 20 | 1:1 HEP:MEK |
| EX17 | 0 | 68 | 0 | 0 | 51 | 21 | 1:1 HEP:MEK |
| EX18 | 0 | 85 | 0 | 0 | 76.5 | 28.5 | 1:1 HEP:MEK |

TABLE 7
Peel Adhesion and Static Shear Test Results

| | Peel Adhesion | Shear 1 kg @ 70° C. |
|---|---|---|
| | (N/dm) | (min) |
| EX11 | 49.9 | NT |
| EX12 | 51.7 | NT |
| EX13 | 91.0 | NT |
| EX14 | 42.7 | 140-300 |
| EX15 | 45.5 | 900-1100 |
| EX16 | 52.5 | 90-110 |
| EX17 | 66.1 | 1700-2000 |
| EX18 | 56.5 | 900-1000 |

NT indicates not tested

Electrical testing was conducted, and the results are represented in Table 8. The samples were attached to CU-1 and then tested.

TABLE 8
Electrical Results

| | ETM-7 (Ω) | PIM (dBm) |
|---|---|---|
| EX11 | 0.40-0.65 | −78.4 |
| EX12 | 0.11-0.16 | −88.3 |
| EX13 | 0.18-0.22 | −72.5 |
| EX14 | 0.35-0.50 | −89.9 |
| EX15 | 0.25-0.50 | −97.8 |
| EX17 | 0.18-0.30 | −91.3 |
| EX18 | 0.25-0.50 | −97.2 |

What is claimed is:

1. A conductive adhesive comprising:
a pressure sensitive adhesive matrix comprising at least one non-linear block copolymer comprising aromatic end blocks and aliphatic elastomeric blocks;
at least one hydrocarbon-based tackifying resin;
at least one aromatic reinforcing resin; and
electrically conductive particles dispersed within the matrix; wherein the conductive adhesive is a pressure sensitive adhesive and when disposed on a 50-micrometer thick polyethylene terephthalate backing has a 180° Peel Adhesion of at least 15.0 Newtons/decimeter at Room Temperature, and when disposed on a copper foil backing has a DC Resistance of less than 0.4 ohms as measured by ETM-7, and wherein the 1800 Peel Adhesion changes by 25% or less after aging on a conductive fabric substrate for at least 1 week at 85° C. and 85% Relative Humidity.

2. The conductive adhesive of claim 1, wherein the at least one non-linear block copolymer comprises a star or comb copolymer.

3. The conductive adhesive of claim 1, wherein the aromatic end blocks comprise styrene blocks, and the aliphatic elastomeric blocks comprise isoprene, farnesene, or a combination thereof.

4. The conductive adhesive of claim 1, wherein the non-linear block copolymer comprises a star copolymer with styrene end blocks and isoprene elastomeric blocks wherein the styrene end blocks comprise 9-10% by weight of the total polymer.

5. The conductive adhesive of claim 1, wherein the at least one hydrocarbon tackifying resin comprises a hydrogenated or partially hydrogenated hydrocarbon resin.

6. The conductive adhesive of claim 1, wherein the at least one aromatic reinforcing resin comprises a thermoplastic aromatic co-polymer with a Tg of greater than 100° C.

7. The conductive adhesive of claim 1, wherein the electrically conductive particles comprise particles of nickel-coated graphite.

8. The conductive adhesive of claim 1, comprising:
a pressure sensitive adhesive matrix comprising:
40-70 parts by weight of at least one non-linear block copolymer;
30-60 parts by weight of hydrocarbon-based tackifying resin;
2-8 parts by weight aromatic reinforcing resin; and
15-30 parts by weight electrically conductive particles.

9. The conductive adhesive of claim 1, wherein the conductive adhesive further comprises at least one additive comprising conductive nanoparticles.

10. The conductive adhesive of claim 9, wherein the conductive nanoparticles comprise carbon nanotubes, metallic nanowires, metallic nanoflakes, metallic nanograins, and metallic nanospheres.

11. The conductive adhesive of claim 9, wherein the conductive nanoparticles comprise carbon nanotubes present in an amount of 0.01-0.1 parts by weight.

12. The conductive adhesive of claim 1, wherein the conductive adhesive can be tested for passive intermodulation by forming a tape, the tape comprising a layer of the conductive adhesive and an electrically conductive layer, and placing the tape in a test fixture comprising gold conductive surfaces, and
wherein when first and second electrical signals propagate in the thickness direction of the conductive adhesive layer between the gold surfaces at respective frequencies F1 and F2, any intermodulation signal generated from the first and second electrical signals having a frequency F3 equal to nF1+mF2, m and n positive or negative integers, has a power of less than about −95 dBm relative to a total power of the first and second signals.

13. An electrically conductive article comprising:
a substrate with a first major surface and a second major surface; and
an electrically conductive adhesive layer disposed on at least a portion of the second major surface of the substrate; wherein the electrically conductive adhesive comprises:
a pressure sensitive adhesive matrix comprising at least one non-linear block copolymer comprising aromatic end blocks and aliphatic elastomeric blocks;
at least one hydrocarbon-based tackifying resin;
at least one aromatic reinforcing resin; and
electrically conductive particles dispersed within the matrix; wherein the conductive adhesive is a pressure sensitive adhesive and when disposed on a 50-micrometer thick polyethylene terephthalate backing has a 180° Peel Adhesion of at least 15.0 Newtons/decimeter at Room Temperature, and when disposed on a copper foil backing has a DC Resistance of less than 0.4 ohms as measured by ETM-7, and wherein the 1800 Peel Adhesion changes by 25% or less after aging on a conductive fabric substrate for at least 1 week at 85° C. and 85% Relative Humidity.

14. The electrically conductive article of claim 13, wherein the substrate comprises an electrically conductive substrate.

15. The electrically conductive article of claim 14, wherein the electrically conductive substrate comprises a non-woven layer comprising metal coated polymer fibers, a woven fabric layer comprising metal coated polymer fibers, a film layer with a metal coated surface, or a metal foil.

16. The electrically conductive article of claim 14, wherein the article further comprises a second layer of conductive adhesive disposed on the first major surface of the electrically conductive substrate.

17. The electrically conductive article of claim 13, wherein the substrate comprises a release liner.

18. The electrically conductive article of claim 13, wherein the at least one non-linear block copolymer comprises a star or comb copolymer.

19. The electrically conductive article of claim 13, wherein the at least one non-linear block copolymer comprises aromatic end blocks comprise styrene blocks, and the aliphatic elastomeric blocks comprise isoprene, farnesene, or a combination thereof.

20. The electrically conductive article of claim 13, wherein the non-linear block copolymer comprises a star copolymer with styrene end blocks and isoprene elastomeric blocks wherein the styrene end blocks comprise 9-10% by weight of the total polymer.
